(19) United States
(12) Patent Application Publication
(10) Pub. No.: US 2026/0019011 A1
(43) Pub. Date: Jan. 15, 2026

(54) HYBRID UNMANNED AERIAL VEHICLES INCLUDING TRIBOELECTRIC NANOGENERATORS

(71) Applicant: City University of Hong Kong, Kowloon (HK)

(72) Inventors: Jasim Mohamed Jasim Mohamed Almardi, Kowloon (HK); Walid Daoud, Kolwoon (HK)

(21) Appl. No.: 18/772,428

(22) Filed: Jul. 15, 2024

(51) Int. Cl. H02N 1/04; B64U 10/14; B64U 30/294; B64U 50/30; B64U 101/00

(52) U.S. Cl. CPC H02N 1/04; B64U 10/14; B64U 30/294; B64U 50/30; B64U 2101/00

(57) ABSTRACT

A hybrid unmanned aerial vehicle includes an aerial unit including a plurality of rotors, and a triboelectric nanogenerator (TENG) system attached to the aerial unit. The TENG system is configured to convert kinetic energy generated by rotations of the plurality of rotors into electrical energy for use as supplemental or alternative power source.

### TECHNICAL FIELD

The present invention relates to hybrid unmanned aerial vehicles including triboelectric nanogenerators and their fabricating methods.

### BACKGROUND

The global drone market is a multibillion-dollar industry that is experiencing a rapid growth. While drones are commonly used for aerial photography, videography, surveying, search and rescue operations, most consumer and enterprise drones have limited onboard electronics other than what is required for basic flight operation. Such limitation is due to payload constraints, where more onboard electronics would require a larger battery pack, which increases the total payload and leads to higher energy consumption.

### SUMMARY OF THE INVENTION

To overcome the limitation mentioned in the background, in some embodiments, a drone rotational triboelectric nanogenerator (DR-TENG) system is developed comprising four units connected to the propellers of a quadcopter drone to capture and recycle the kinetic energy of the propellers' rotational energy for use as a supplemental power supply for onboard electronics. For example, four DR-TENGs can be connected as a system below the four propellers of a quadcopter drone to turn the rotational energy harvested into electrical energy for use as an alternative or supplemental power source. In these embodiments, it is reported that a drone rotational triboelectric nanogenerator system achieves a high surface power density of 3.4 W/m², charges capacitors, and operates as a self-powered RPM sensor.

In a first aspect, there is provided a hybrid unmanned aerial vehicle, which includes an aerial unit including a plurality of rotors, and a triboelectric nanogenerator (TENG) system attached to the aerial unit. The TENG system is configured to convert kinetic energy generated by rotations of the plurality of rotors into electrical energy for use as supplemental or alternative power source.

Optionally, the aerial unit may include a quadcopter including four rotors.

Optionally, the TENG system may include a corresponding number of TENG units for the plurality of rotors. Optionally, the TENG units may be respectively provided to the plurality of rotors of the aerial unit.

Optionally, the TENG units may be respectively directly connected to the plurality of rotors of the aerial unit below respective propellers.

Optionally, each of the TENG units may include a rotor component and a stator component in a co-planar arrangement.

Optionally, the rotor component may include a rotor substrate attached to a respective rotor of the aerial unit, and a dielectric triboelectric layer attached to at least a part of the rotor substrate. Optionally, the stator component may include a stator substrate and a conductive layer attached to at least a part of the stator substrate on a side facing the rotor component.

Optionally, the dielectric triboelectric layer may include a fluorinated ethylene propylene (FEP) film.

Optionally, the conductive layer may include silver (Ag). Optionally, the Ag conductive layer may be configured as a fabric tape.

Optionally, the stator substrate may include a curved end on the side facing the rotor component, and the conductive layer may be provided on the curved end.

Optionally, the rotor component may be ring-shaped to surround the rotor of the aerial unit, and the stator component may be installed on a body of the aerial unit.

Optionally, at least a part of the stator component may be incorporated or embedded in the body of the aerial unit.

Optionally, a first diagonal pair of rotors and a second diagonal pair of rotors may rotate in different directions, and the rotors in each diagonal pair may rotate in the same direction.

Optionally, the TENG units connected to the rotors with matching rotational direction may be connected in series, and a first pair of the TENG units and a second pair of the TENG units with opposite rotational directions may be connected in parallel.

Optionally, each TENG unit may be configured such that the dielectric triboelectric layer comes into near-contact with the conductive layer with every rotation of the respective rotor of the aerial unit.

Optionally, each TENG unit may be configured to collect electrical energy by rotations of the respective rotor of the aerial unit.

Optionally, each TENG unit may function as a rotation sensor or an RPM sensor.

Optionally, the hybrid unmanned aerial vehicle may further include a power storage unit to store the converted electrical energy.

Optionally, the hybrid unmanned aerial vehicle may further include one or more electronic components. The converted electrical energy may be utilized to power the one or more electronic components.

In a second aspect, there is provided a method of fabricating a triboelectric nanogenerator (TENG) unit for a hybrid unmanned aerial vehicle. The TENG unit includes a stator component including a stator substrate and a conductive layer, and a rotor component including a rotor substrate and a dielectric triboelectric layer. The method includes providing the stator substrate and the rotor substrate by using 3D printing method, attaching the dielectric triboelectric layer to at least a part of the rotor substrate, and attaching the conductive layer to at least a part of the stator component.

Optionally, the method may further include providing the rotor component to a rotor of the hybrid unmanned aerial vehicle such that the rotor component is directly connected to the rotor of the hybrid unmanned aerial vehicle below a corresponding propeller, and providing the stator component to the hybrid unmanned aerial vehicle such that the rotor component and the stator component are provided in a co-planar arrangement.

Other features and aspects of the disclosure will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

Embodiments of the invention will now be described, by way of example, with reference to the accompanying drawings in which:

FIGS. 1A to 1D show components of a drone rotational triboelectric nanogenerator (DR-TENG) in different views according to an embodiment of the invention.

FIG. 2A illustrates a hybrid unmanned aerial vehicle including a drone rotational triboelectric nanogenerator (DR-TENG) according to an embodiment of the invention; FIG. 2B shows an expanded view of the hybrid unmanned aerial of FIG. 2A;

FIG. 2C shows component details of a DR-TENG according to an embodiment of the invention; FIG. 2D is a diagram showing a DR-TENG according to an embodiment of the invention; FIG. 2E illustrates a movement mechanism of a DR-TENG according to an embodiment of the invention; FIG. 2F shows a working principle of a TENG according to an embodiment of the invention; and FIG. 2G shows electrical potential simulation of a DR-TENG unit under open-circuit condition.

FIG. 3A and FIG. 3B show open-circuit voltage and short-circuit current measurements of DR-TENG respectively when drone propeller motors operate at maximum speed; FIG. 3C shows voltage and current measurements under increasing load resistance; FIG. 3D shows power output and power density under increasing load resistance; FIG. 3E and FIG. 3F show rectified open-circuit voltage and short-circuit current of DR-TENG respectively.

FIG. 4A shows capacitor charging performance of a DR-TENG for capacitors of different sizes in an embodiment; FIG. 4B shows voltage signals of a DR-TENG when the propellers are operated at different speeds in an embodiment; and FIG. 4C shows a simplified circuit diagram for DR-TENG's connection to power up LEDs in an embodiment.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Hereinafter, some embodiments of the invention will be described in detail with reference to the drawings.

### Drone Rotational Triboelectric Nanogenerator for Supplemental Power Generation and RPM Sensing

Unmanned aerial vehicles (UAVs), commonly referred to as drones, have transformed numerous industries by providing versatile platforms for various tasks including aerial photography, videography, surveying, mapping, environmental monitoring, surveillance, search and rescue operations and many other tasks in various professional industries. However, their dependence on limited onboard power sources, typically batteries, significantly restricts their flight duration and operational capabilities. To address this limitation, researchers have been investigating alternative power solutions, with energy harvesting technologies emerging as a promising avenue. Among the energy harvesting technologies, triboelectric nanogenerators (TENGs) convert mechanical energy into electrical energy through the triboelectric effect and electrostatic induction [1]. TENGs can offer several advantages for drone applications, including their lightweight nature, flexibility, and compatibility with diverse environments. By harnessing onboard energy sources, TENGs have the potential to improve the overall energy autonomy of drones. Rotational TENGs, a specific configuration of TENGs, can be a viable approach for wind, water, and biomechanical energy harvesting [2]. These devices exploit the relative motion between rotating components and a stationary part to generate electrical power. By capturing the propeller-induced rotational motion, rotational TENGs could enable efficient energy conversion and provide a near self-powered solution for drones. Numerous studies have focused on the development and optimization of rotational TENGs for various types of kinetic energy harvesting. Researchers have explored various design aspects such as rotor configurations, material selection, and electrode arrangements to enhance the performance of rotational TENGs [3-5]. The selection of materials for the rotor and stator components is crucial to ensure effective triboelectric charging and electrostatic induction [6-7]. However, investigations into the integration of rotational TENGs with drone systems have not been conducted to evaluate their practicality and effectiveness.

One of the main advantages of TENGs is their ability to power up small electronics for IoT applications [8]. Drones rely on a range of onboard electronic components and systems to perform their tasks effectively [9]. These include navigation systems, communication modules, cameras, and payload equipment, among others. By integrating TENGs into drone designs, the harvested energy can be directly utilized to power these essential electronic components. TENGs can provide a supplemental power source to keep these systems operational, reducing the dependence on traditional batteries and increasing the capabilities of drones by the added onboard electronics without sacrificing flight time. Moreover, sensors play a crucial role in drones for various purposes, such as mapping and surveying, environmental monitoring, altitude measurements, infrastructure monitoring applications and other intelligent interfaces [10-17]. TENGs can power up these sensors, allowing drones to collect and analyze data in real-time without depleting their primary power sources. This enables extended flight missions and enhances the drone's ability to adapt to changing environments.

The complex interplay between the geometric parameters, materials, and interface conditions necessitates further investigation to optimize the performance in terms of energy conversion efficiency and output power of rotational TENGs [18-20]. Numerical simulations and experimental studies can provide valuable insights into the energy transfer processes within rotational TENGs and guide the development of more efficient designs [21-22]. Furthermore, the durability and stability of rotational TENGs in real-world drone applications require careful consideration [23-29]. Drones are subjected to varying wind speeds, vibrations, and environmental conditions [30-31], all of which can influence the performance and longevity of rotational TENGs. Moreover, the integration of rotational TENGs with existing drone systems necessitates careful design considerations. Even though hybrid rotational systems involving TENGs combined with piezoelectric or electromagnetic generators have been reported in wind energy harvesting studies [32-33], their integration in quadcopter drone systems was not investigated due to mechanical compatibility, size and weight constraints. The size, weight, and form factor of the TENGs should be compatible with the drone's structure and aerodynamics. The placement of the rotational TENGs should be strategically determined to maximize the rotational movement energy harvesting and minimize interference with other components. Additionally, the power management and distribution systems within the drone must be efficiently designed to handle the harvested energy and ensure its proper allocation to different electronic components.

To overcome these challenges and advance the practical implementation of rotational TENGs in drones, a drone TENG (DR-TENG) system is introduced in an embodiment which directly harvests and recycles the rotational energy from the propellers of a quadcopter drone, with the rotor component of DR-TENG directly attached to the rotors of the drone propeller motors, ensuring maximum rotational energy harvesting with no aerodynamic interference. Some embodiments of the invention provide a DR-TENG system for quadcopter drones, demonstrating its novel design and functionality. DR-TENG shows an open circuit voltage of 3.6 V with a surface power density of 3.4 W/m². The integration of rotational TENGs into drones can lead to potentially enabling a broader range of applications with self-powered onboard electronics, such as sensors, enhanced operational efficiency, and extended flight durations.

### 1. MATERIALS AND METHODS

### 1.1. Structure and Design

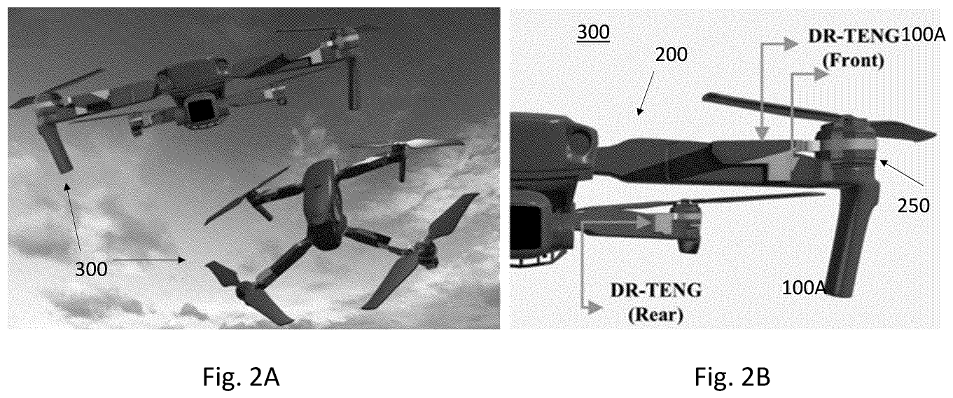

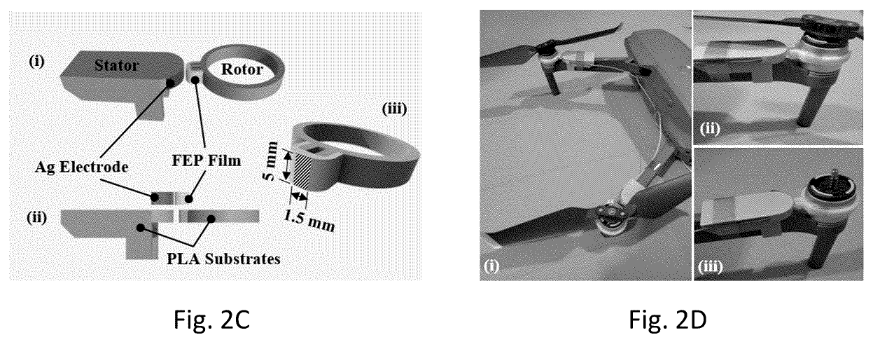

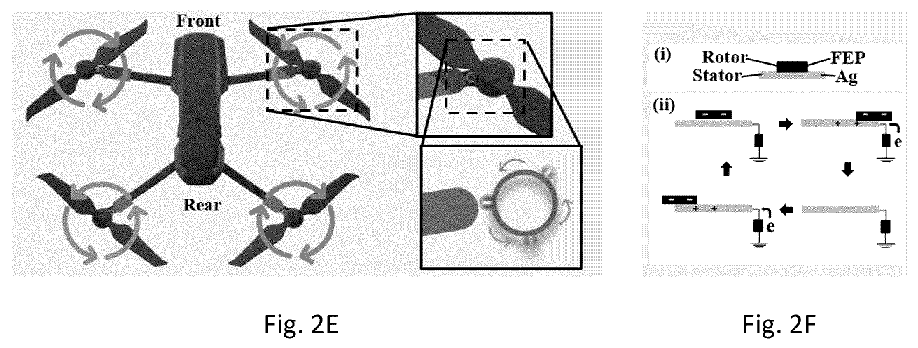

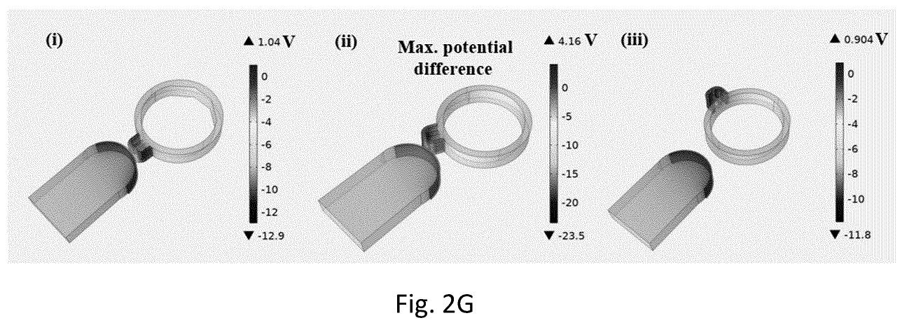

In some embodiments, a hybrid unmanned aerial vehicle 300 includes an aerial unit 200 including a plurality of rotors 250, and a triboelectric nanogenerator (TENG) system 100 attached to the aerial unit 200 (see FIG. 2A and FIG. 2B). The aerial unit 200 may be a quadcopter including four rotors 250. The TENG system 100 may be a drone rotational TENG (DR-TENG) system. The TENG system 100 may include a corresponding number of TENG units 100A for the plurality of rotors 250. If the aerial unit 200 is a quadcopter, the DR-TENG system 100 will include four TENG units 100A. The TENG units 100A are respectively provided to the plurality of rotors 250 of the aerial unit 200. In particular, the TENG units 100A are respectively directly connected to the rotors 250 of the aerial unit 200 below respective propellers.

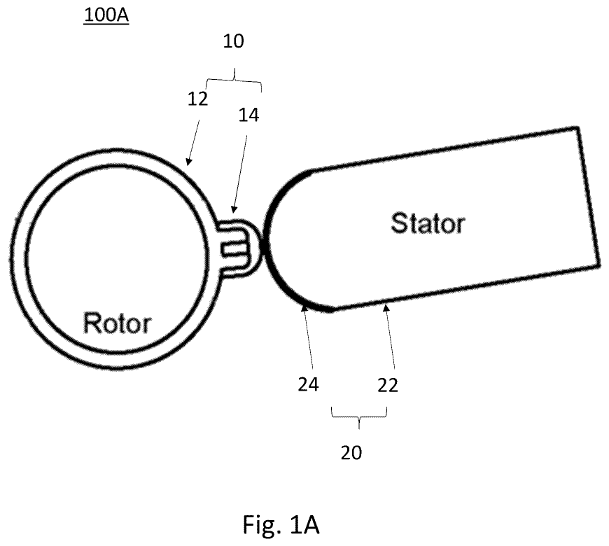

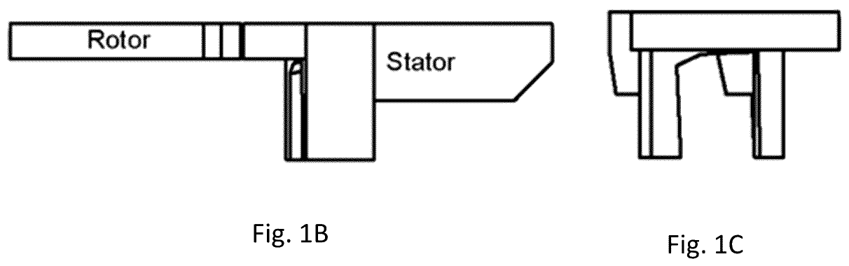

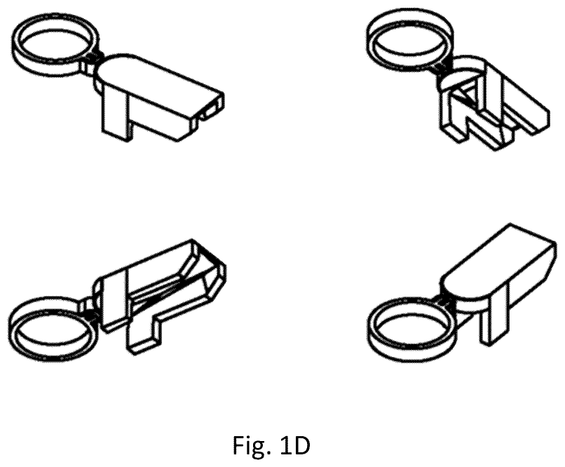

FIGS. 1A to 1D show components of the DR-TENG system (in particular, the TENG unit 100A) in different views according to some embodiments. As shown in FIG. 1A (top view), each of the TENG units 100A may include a rotor component 10 and a stator component 20. The rotor component 10 includes a rotor substrate 12 and a dielectric triboelectric layer 14 attached to at least a part of the rotor substrate 12. The stator component 20 includes a stator substrate 22 and a conductive layer 24 attached to at least a part of the stator substrate 22 on a side facing the rotor component 10. In some embodiments, the stator substrate 22 includes a curved end on the side facing the rotor component 10, and the conductive layer 24 is provided on the curved end of the stator substrate 22. The rotor component 10 can be ring-shaped to surround the rotor of the aerial unit 200, and the stator component 20 can be installed on a body of the aerial unit 200. For example, at least a part of the stator component 20 is incorporated or embedded in the body of the aerial unit 200. FIGS. 1B and 1C provide side views of the DR-TENG unit 100A in FIG. 1A, and FIG. 1D provides isometric views of the DR-TENG unit 100A in FIG. 1A.

### 1.2. Fabrication

The fabrication of the drone rotational triboelectric nanogenerator (DR-TENG) system can be carried out using, for example, Shapr3D, a modeling software, for the complete design process (see FIGS. 1A to 1D for components of the DR-TENG system in different views in an embodiment). The substrate, comprising both stator and rotor components 12, 22, can be fabricated using 3D printing method, for example, Flashforge Adventurer 3 3D printer. In some embodiments, flexible polylactic acid (FPLA) can be chosen as the material for 3D printing due to its desirable mechanical properties for the intended application. For a dielectric material for the dielectric triboelectric layer 14, in some embodiments, a fluorinated ethylene propylene (FEP) sheet can be employed as an integral part of the DR-TENG's design. The FEP sheet, known for its high dielectric constant, is utilized to ensure efficient energy conversion within the device. It can be sourced as a commercially available product. For an electrode material for the conductive layer 24, in some embodiments, silver (Ag) conductive fabric cloth tape can be selected. The Ag conductive fabric cloth tape offers excellent conductivity and durability, making it suitable for the DR-TENG's electrode requirements. Similar to the dielectric material, the Ag conductive fabric cloth tape can be obtained as a commercially available product.

The fabrication process may involve precise 3D printing of the substrate components 12, 22 using, for example, Flashforge Adventurer 3 3D printer. The design specifications developed using Shapr3D are translated into printable files compatible with the 3D printer.

Following the 3D printing of the substrate (i.e., the rotor substrate 12 and the stator substrate 22), the FEP sheet 14 and Ag conductive fabric cloth tape 24 are integrated into the design as dielectric and electrode materials, respectively. The FEP sheet 14 is cut and attached to the rotor substrate 12. The silver cloth tape 24 is attached to the stator substrate 22 to act as the single electrode for each DR-TENG unit 100A.

As described, the DR-TENG unit 100A includes the stator component 20 and the rotor component 10.
a) Stator component: The stator component consists of 2 parts, the substrate (i.e., the stator substrate 22), and the electrode (i.e., the conductive layer 24). The substrate can be designed using CAD and 3D printed with flexible polylactic acid material. For the electrode material, silver (Ag) conductive fabric cloth tape can be selected and adhered directly to the curved end of the substrate. The Ag conductive fabric cloth tape can be obtained as a commercially available product.
c) Rotor component: The rotor component consists of 2 parts, the substrate (i.e., the rotor substrate 12) (also designed using CAD and 3D printed with flexible polylactic acid) attached directly to the rotor of the drone's propeller, and the dielectric triboelectric layer 14, i.e., a sheet of fluorinated ethylene propylene (FEP) of 0.2 mm thickness attached to it.

### 1.3. Characterizations and Measurements

The characterization of the DR TENG is performed to assess its electrical performance and energy conversion capabilities. The open-circuit voltage (V_{oc}) and short-circuit current (I_{sc}) are measured, for example, using a Keithley 6514 system electrometer. The characterization experiments are conducted under specific conditions to simulate the maximum propeller speed of the drone. To achieve this, the propellers of the drone are removed while the motor is operated at its maximum speed, corresponding to take-off or ascending motor speed. This configuration allows for the simulation of the maximum RPM without the drone taking flight. The V_{oc}, representing the voltage output with no external load connected, is measured to evaluate the device's ability to generate electrical potential. Furthermore, the I_{sc}, which represents the current flow when the device is directly connected without any external resistance, is measured to assess the maximum current output capability of DR-TENG. Multiple measurements are performed to confirm the reliability and consistency of the obtained data. Experimental setup is carefully calibrated, and the measurements are recorded under stable conditions to minimize any external factors that could influence the results.

By conducting the characterization experiments under the simulated maximum propeller speed conditions, the performance of DR-TENG is evaluated at its optimal operating point. This approach allows for an accurate assessment of the device's energy conversion capabilities without the drone being in flight. The recorded V_{oc} and I_{sc} data provide valuable information on the electrical output characteristics of DR-TENG.

TABLE 1
Specifications and electrical output for DR-TENG system

| | | | Dielec- | Electric | Electric |
|---|---|---|---|---|---|
| | DR-TENG unit | Electrode | tric | Output | Output |
| Device | Specification | Material | Material | V_{OC}/V | I_{SC}/μA |
| DR-TENG | 2 piece stator | Ag | FEP sheet | 3.6 | 0.8 |
| System | (substrate and | conductive | | | |
| (consists | electrode) and 2 | fabric | | | |
| of 4 | piece rotor | cloth | | | |
| DR-TENG | (substrate and | tape | | | |
| units) | dielectric | | | | |
| | material) | | | | |

### 2. RESULTS

### 2.1. Structural Design and Working Principle

The DR-TENG system according to some embodiments of the invention can recycle the kinetic energy from the drone propeller motor's rotation to also generate electricity. This system involves capturing and converting energy that would otherwise go to waste, and the subsequent utilization of this energy improves the overall system efficiency. According to the hybrid unmanned aerial vehicle including the DR-TENG system according to some embodiments of the invention, by connecting the DR-TENG system to the aerial unit (i.e., drone), recycling of the propellers rotational energy occurs. The recycled energy is transformed into electrical energy for use as an alternative power source for onboard electronics. The DR-TENG system can also work as a self-powered propeller RPM sensor.

According to some embodiments, DR-TENG is designed as a lightweight add-on system that could be installed on the body of a quadcopter drone without affecting its flying ability (FIG. 2A). To ensure negligible aerodynamic interference, each DR-TENG 100A is directly connected to the motor below each propeller (FIG. 2B). Unlike conventional rotational TENGs with rotors and friction layers stacked on top of the stationary stator electrodes, DR-TENG is designed to have the rotor positions beside the stator electrode in a co-planar arrangement (FIG. 2C). Electrical power generation is achieved through combining of the triboelectric and electrostatic induction effects when the propeller's motor rotates, allowing the rotor of DR-TENG to rotate simultaneously. The rotor of each DR-TENG unit has a sheet of FEP film attached to it, acting as the dielectric (polymer) triboelectric layer (FIG. 2C). As for the stator of DR-TENG, silver (Ag) conductive tape (i.e., Ag conductive fabric cloth tape) can be used as the electrode material (FIG. 2C). The dimension of the near-contact surface area is, for example, 7.5 mm² (FIG. 2C). Diagrams of the DR-TENG system are provided in FIG. 2D for example. The fabricated DR-TENG system set-up is shown in FIG. 2D. In an example, the DR-TENG system consists of four DR-TENG units, one for each propeller of the quadcopter drone (FIG. 2E). Each diagonal pair of propellers rotate in the same direction. The two pairs rotate in different directions. For example, a first pair of propellers in the left-top side and the right-bottom side rotate clockwise, and a second pair of propellers in the left-bottom side and the right-top side rotate counterclockwise. Connecting the DR-TENG units of the propellers with matching rotational direction in series and combining both pairs in parallel allows the combined DR-TENG system to achieve the maximum electrical output. No friction is induced between the rotors and the stators of DR-TENG, however, since the device is designed as a freestanding-mode TENG, the FEP film comes into near-contact with the Ag electrode with every rotation of the propeller motor. After near-contact, when the pair is separated, the triboelectric material (i.e., the FEP film) retains its charge, while the other material (i.e., the Ag electrode) loses its charge. This separation creates an electrical potential difference between the FEP film and the Ag electrode. Due to the electrostatic induction effect, the electrical potential difference between the FEP film and the Ag electrode causes the flow of electrons. As a result, an electrical current is generated in the external circuit connected to the Ag electrode, which allows for the extraction of usable electrical energy. The device's cross-section and TENG working principle are shown in FIG. 2F. Multiphysics Boundary Element Method (BEM) calculation is used for electrostatics system simulation under open-circuit condition to visualize the operation mechanism of DR-TENG as shown in FIG. 2G. The potential distribution at three representative positions is shown in FIG. 2G, where the simulation results confirm the theoretical analysis and the open-circuit experimental results in section 2.2 (Performance of DR-TENG). The electrostatics simulation configuration for BEM is summarized in Table 2.

TABLE 2
Electrostatics simulation configuration

| Simulation | Configuration |
|---|---|
| Physics | Electrostatics (3D BEM) |
| Boundary | Floating potential: Ag electrode inner surface (Q₀ = 0 C) |
| condition | Ground: Ag electrode inner surface (V = 0) |
| Material | Air: infinite void |
| Properties | FEP: dielectric sheet on rotors' inner surfaces |
| Applied | Ag: electrodes |
| charges | Surface charge density 1: FEP film outer surface |
| | (−55e−9 C/m²) |
| | Surface charge density 2: Ag electrode outer surface |
| | (25e−9 C/m²) |
| Study | Stationary |

### 2.2. Performance of DR-TENG

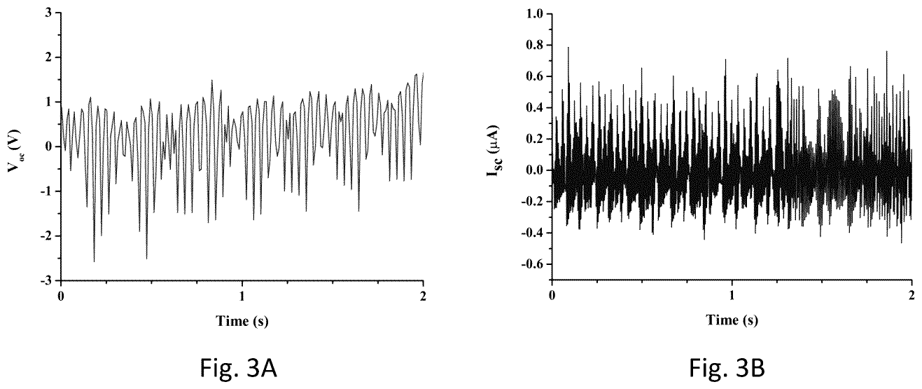

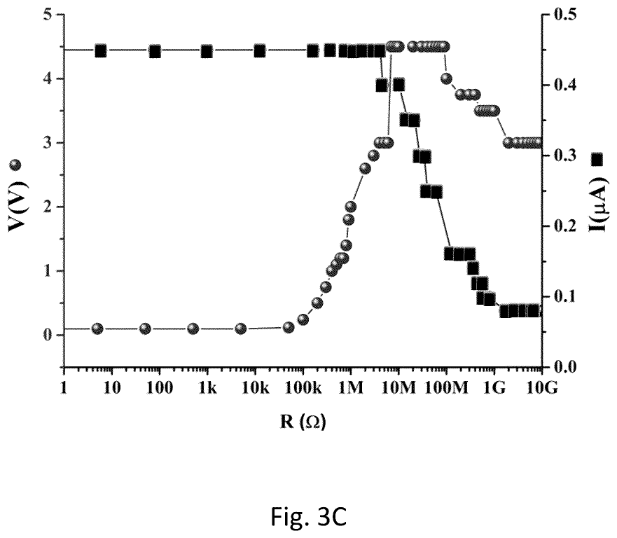

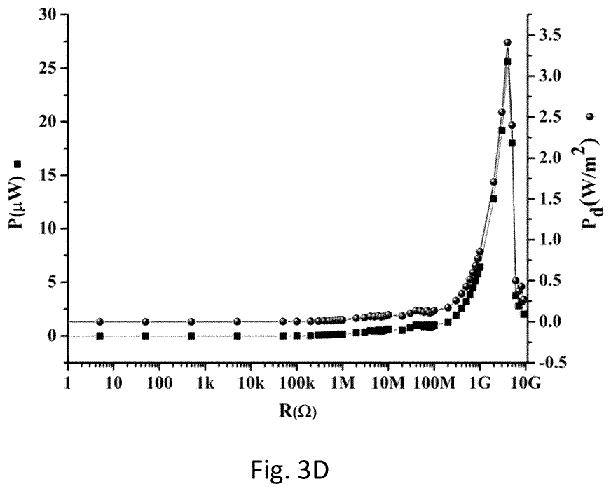

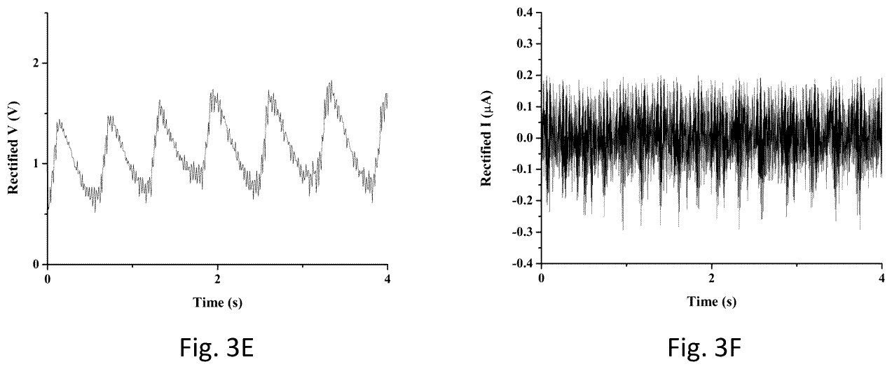

The propellers of a drone (for example, a Mavic 2 Pro drone) are removed and DR-TENG is connected to the rotors of the propellers' motors to simulate flight mode. The motors of the drone's propellers work regardless of whether the propellers are attached. Each propeller motor has a hovering and ascending rotational speed of approximately 5000 and 10000 RPM respectively. DR-TENG is able to achieve a maximum V_{oc} of 3.6 V, and a maximum I_{sc} of 0.8 μA when the drone's motors are operated at maximum rotational speed during ascending. FIG. 3A and FIG. 3B show the V_{oc} and I_{sc} measurements under maximum propeller motor operation speed. The power output and power density are calculated using equations (1) and (2) respectively.

$$P = {I}^{2} R \qquad ( 1 )$$

$${P}_{d} = P \div A \qquad ( 2 )$$

The power density is calculated based on the power output divided by the near-contact surface area of the electrode of DR-TENG. FIG. 3C and FIG. 3D show the voltage, current and power measurements under increasing load resistance when DR-TENG is tested at maximum drone propeller speed. DR-TENG achieves a peak power output of 25 μW and a power density of 3.4 W/m² with a matched resistance of 3 GΩ. The rectified voltage and current are 1V and 0.3 μA, respectively (FIG. 3E and FIG. 3F).

### 2.3. Applications of DR-TENG

The ability of DR-TENG system to work as an efficient supplemental power supply system is investigated, particularly in powering small electronics through capacitor charging. The system's ability to convert the mechanical energy of the propeller motor's rotational movement into electrical energy opens up new possibilities for sustainable energy solutions. By connecting to a bridge rectifier (DB105), the AC output of DR-TENG is converted to DC output for charging capacitors and supplying power to electronic devices.

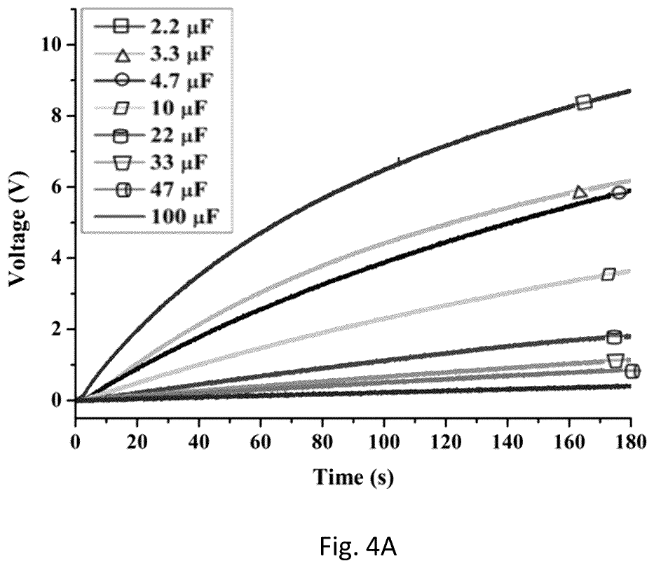

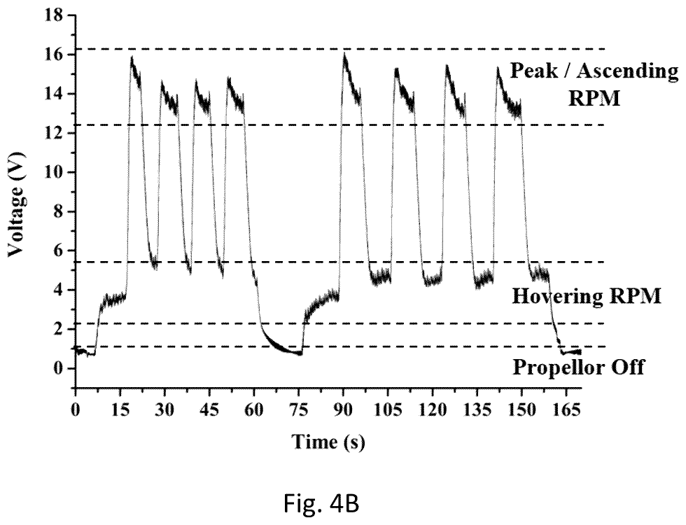

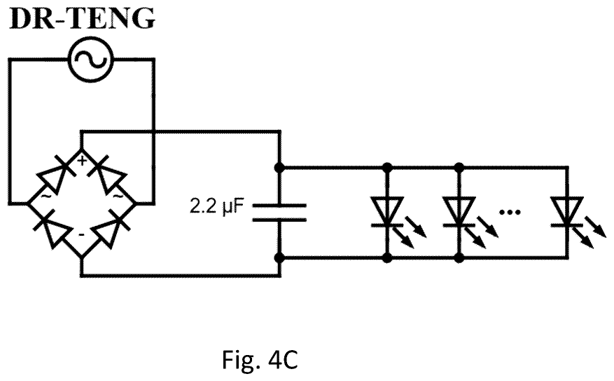

During testing, the DR-TENG charges a 2.2 μF capacitor for 3 minutes. The DR-TENG exhibited notable charging results over a 3-minute period for capacitors of different sizes as shown in FIG. 4A. A 2.2 μF capacitor is charged by DR-TENG operating under maximum RPM during ascending reached 8.7 V, demonstrating capability to supply sufficient power to small capacitors. Meanwhile, 10 μF and 47 μF capacitors reached 3.7 V and 0.9 V in 3-minute, respectively, demonstrating potential to power capacitors with higher storage capacity. Therefore, a 100 μF capacitor is also studied reaching 0.4 V in the same charging period. The capacitor charging results demonstrate the ability of DR-TENG system to convert mechanical energy into electrical energy, offering a sustainable and reliable solution for various onboard drone applications.

In addition, DR-TENG demonstrates versatility by working as a self-powered sensor of rotational movement, specifically for monitoring the propellers of a drone. After the AC output is converted to DC output using a bridge rectifier, DR-TENG reaches a rectified voltage range of 13 to 16 V during peak RPM operation and approximately 2.5 to 5.5 V during hovering RPM (FIG. 4B). This voltage variation serves as a reliable indicator of the propellers' rotational speeds and provides valuable feedback on the drone's performance during different flight modes. The self-powering capability of DR-TENG is a notable feature, as it harnesses the mechanical energy of the propellers' rotation to monitor the RPM without external power supply. The voltage range observed in the rectified DC output offer real-time information on the propellers' speeds. By integrating the self-powered RPM sensor in drones, the device offers enhanced control and monitoring capabilities. Operators can rely on immediate feedback on the propellers' rotational speeds, allowing them to maintain appropriate speeds in different flight modes.

Another application of DR-TENG is powering LEDs. During testing, DR-TENG is used to power up commercial 5 mm LEDs connected in parallel, and the rectified output from the system is utilized to charge a 2.2 μF capacitor for a duration of 10 seconds. The energy stored in the capacitor is used to power a series of 10 5-mm LEDs connected in parallel. A schematic diagram of the LED circuit is shown in FIG. 4C. With the stored energy in the capacitor, the system can provide a stable power supply for the LEDs, enabling them to operate for an extended period. This application highlights the system's ability to deliver sufficient power to drive multiple LEDs, making it suitable for a range of lighting applications.

In an example, the total weight of DR-TENG can be about 17.48 g. For example, a front DR-TENG stator weighs 4.37 g, a back DR-TENG stator weighs 2.81 g, and a DR-TENG rotor weighs 0.78 g. Therefore, the total weight of DR-TENG with two front DR-TENG stators, two back DR-TENG stators and four DR-TENG rotors (excluding wiring) is (4.37 g×2)+ (2.81 g×2)+ (0.78 g×4)=17.48 g. This weight is negligible for impacting the flight time, where the battery depletion rate of 20% with and without DR-TENG for a flight time of 5 minutes is identical. For example, it is shown that drone battery level is 96% at start of hovering with DR-TENG, drone battery level is 76% after 5 min of hovering with DR-TENG, drone battery level is 72% at start of hovering without DR-TENG (when battery not re-charged after removing DR-TENG), drone battery level is 52% after 5 min of hovering without DR-TENG (when battery not re-charged after removing DR-TENG), drone battery level is 96% at start of hovering without DR-TENG (when battery re-charged to 100% after removing DR-TENG), and drone battery level is 76% after 5 min of hovering without DR-TENG (when battery re-charged to 100% after removing DR-TENG). The quadcopter drone itself weighs, for example, 907 grams, making the additional weight of DR-TENG a mere 1.93% of the total drone weight. The design of the quadcopter drone allows it to operate in various conditions and provide a certain level of flexibility in terms of carrying additional weight without increasing battery energy consumption. The minimal increase in weight is carefully considered, ensuring that the added weight does not impact the drone's electrical energy consumption or compromise its flight performance. In addition, the conservation of energy is maintained as the electrical energy produced by DR-TENG is derived from the kinetic energy of the propellers and is only converted within the closed system.

### 3. CONCLUSIONS

DR-TENG represents a groundbreaking development in the realm of drones integrated with sustainable energy technologies. In addition, DR-TENG offers a higher power density compared to other rotational-based TENGs (see Table 3 below). The fundamental operation of DR-TENG relies on the triboelectric effect, where two materials—with different electron affinities-come into near-contact and separation with one another, causing the transfer of electrons and the generation of static electricity. The dielectric triboelectric FEP film within the DR-TENG's rotor facilitates this electron transfer. As the propeller of the drone rotates, the FEP film fixed on the rotor and attached to the propeller's motor makes near-contact with the fixed electrode on the stator, creating a charge imbalance that generates an AC output. To convert the AC output into a usable DC output, a bridge rectifier is employed. This rectified DC output is used to power a wide range of electronic devices. Notably, DR-TENG showcases a high power density of 3.4 W/m², making it particularly well-suited for powering small-scale electronics, as demonstrated in charging capacitors and lighting up LEDs.

TABLE 3
Comparison of output and design attributes with prominent
literature on rotational-based triboelectric nanogenerators

| Journal and | | | | | | Surface | Power |
|---|---|---|---|---|---|---|---|
| Reference | TENG | | Testing RPM/ | | Output | Area | Density |
| No. | Structure | Application | Wind Speed | | Performance | (mm²) | (W/m²) |
| Sensors and | Cylindrical | Fault | 600 | RPM | V_{oc}: 26.56 V | 3299 | 0.019 |
| Actuators: A. | | Diagnosis | | | I_{sc}: 2.45 μA | | |
| Physical [34] | | and Smart | | | | | |
| | | Bearings | | | | | |
| Nano Energy | Cylindrical | Wind | 1.5 | m/s | V_{oc}: 40 V | 3770 | 0.039 |
| [35] | | energy | | | I_{sc}: 2 μA | | |
| | | harvesting | | | | | |
| Nano Energy | Cylindrical | Wind | 8 | m/s | V_{oc}: 120 V | 2206 | 0.090 |
| [36] | | energy | | | I_{sc}: — | | |
| | | harvesting | | | | | |
| Advanced | Disc | Wind | 800 | RPM | V_{oc}: 2000 V | — | 0.200 |
| Functional | | energy | | | I_{sc}: ~60 μA | | |
| Materials | | harvesting | | | | | |
| [37] | | | | | | | |
| Materials | Rotational | Wind | 10 | m/s | V_{oc}: 450 V | 2513 | 1.970 |
| Today | hexagonal | energy | | | I_{sc}: 11 μA | | |
| Energy [38] | | harvesting | | | | | |
| Applied | Cylindrical | Wind | 4 | m/s | V_{oc}: 330 V | 10880 | 0.258 |
| Energy [39] | | energy | | | I_{sc}: 7 μA | | |
| | | harvesting | | | | | |
| ACS Energy | Disc | Wind | 600 | RPM | V_{oc}: 141 V | 70685 | 0.707 |
| Letters [40] | | energy | | | I_{sc}: 207 nA | | |
| | | harvesting | | | | | |
| Some | Co-planar | Drone | ~10,000 | RPM | V_{oc}: 3.6 V | 7.5 | 3.400 |
| embodiments | | propeller | | | I_{sc}: 0.8 μA | | |
| of the | | energy | | | | | |
| invention | | recycling | | | | | |

The major advantage of DR-TENG lies in its design. The system's minimal weight is attributed to its simple yet efficient configuration, thereby minimizing the burden on the drone's overall weight and energy consumption. DR-TENG comprises a minimal number of components, which reduces complexity and facilitates its integration in current drone systems. Ease of fabrication is another notable design advantage, where its construction utilizes widely accessible and cost-effective materials.

The other advantage of DR-TENG is its ability to recycle the otherwise wasted energy generated by the propeller's rotation. Traditional quadcopter drones rely on batteries or fuel cells for power, which limits their flight time and operational capabilities. With the integration of DR-TENG, the drone becomes self-sufficient, continuously harvesting and utilizing the energy produced during flight to power additional onboard electronics. The impact of this technological advancement extends beyond the realm of quadcopter drones. The diverse range of applications of DR-TENG demonstrates potential impact across various industries. The self-powered RPM sensor allows for real-time monitoring of propeller speeds, which enhances flight safety and optimizes drone performance. The self-powered RPM sensor could also be utilized in other systems, such as wind turbines, hydropower generators, hybrid cars and other rotating machinery where rotational speed monitoring is necessary.

In summary, some embodiments of the invention introduce an innovative system that harnesses the rotational movement of drone propellers to generate electrical energy. With its lightweight design, minimal number of components, ease of fabrication using widely accessible and cost-effective materials, DR-TENG offers significant advantages and thus paves the way for a greener and more sustainable future within the drone industry.

### Example Features of Some Embodiments

a) Some embodiments of the invention are related to triboelectric nanogenerators. This drone triboelectric nanogenerator (DR-TENG) system consists of rotors and stators that are designed to be connected to the body of quadcopter drones to directly recycle the rotational energy from the propellers and convert it into useful electrical energy for use as an alternative power source.
b) Some embodiments of the invention improve the design of triboelectric-based rotational nanogenerators with a minimal number of components and a simple fabrication process.
c) Some embodiments of the invention introduce a unique method to monitor propeller's rotation by having a self-powered triboelectric nanogenerator work as a propeller's rotation (i.e., RPM) sensor.

### Example Functions and Applications of Some Embodiments

The main function of some embodiments of the invention is to harvest the kinetic energy from the propellers of quadcopter drones and recycle it into useful electrical energy for use as an alternative power source to power onboard electronics or extend battery life.

### Example Advantages of Some Embodiments

a) Some embodiments of the invention provide a lightweight system that does not affect battery consumption after it's attached to the drone.
b) Some embodiments of the invention do not interfere with aerodynamics of flight.
c) Some embodiments of the invention achieve a high power density of 3.4 W/m².
d) Some embodiments of the invention are proven scalable by increasing the number of units.
e) Individual DR-TENG units can move independently of one another.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features. Some embodiments of the invention may lack one or more of these optional features.

### REFERENCES

[1]. Yan, J.; Tang, Z.; Mei, N.; Zhang, D.; Zhong, Y.; Sheng, Y. Research Progress on the Application of Triboelectric Nanogenerators for Wind Energy Collection. Micromachines 2023, 14, 1592. doi.org/10.3390/mi14081592
[2]. Segkos, A.; Tsamis, C. Rotating Triboelectric Nanogenerators for Energy Harvesting and Their Applications. Nanoenergy Adv. 2023, 3, 170-219. dx.doi.org/10.3390/nanoenergyadv3030010
[3]. Li, Z.; Zhang, S.; Guo, H.; Wang, B.; Gong, Y.; Zhong, S.; Peng, Y.; Zheng, J.; Xiao, X. On the Performance of Freestanding Rolling Mode Triboelectric Nanogenerators from Rotational Excitations for Smart Tires. Nano Energy 2023, 113, 108595. doi.org/10.1016/j.nanoen.2023.108595
[4]. Kim, T.; Chung, J.; Kim, D. Y.; Moon, J. H.; Lee, S.; Cho, M.; Lee, S. H.; Lee, S. Design and Optimization of Rotating Triboelectric Nanogenerator by Water Electrification and Inertia. Nano Energy 2016, 27, 340-351. doi.org/10.1016/j.nanoen.2016.06.051
[5]. Xia, Z.; Feng, P.-Y.; Jing, X.; Li, H.; Mi, H.-Y.; Liu, Y. Design and Optimization Principles of Cylindrical Sliding Triboelectric Nanogenerators. Micromachines 2021, 12, 567. doi.org/10.3390/mi12050567
[6]. Si, J.; Duan, R.; Zhang, M.; Liu, X. Recent Progress Regarding Materials and Structures of Triboelectric Nanogenerators for AR and VR. Nanomaterials 2022, 12, 1385. doi.org/10.3390/nano12081385
[7]. Zhao, Z.; Zhou, L.; Li, S.; Liu, D.; Li, Y.; Gao, Y.; Liu, Y.; Dai, Y.; Wang, J.; Wang, Z. L. Selection Rules of Triboelectric Materials for Direct-Current Triboelectric Nanogenerator. Nature Communications 2021, 12 (1). doi.org/10.1038/s41467-021-25046-z
[8]. Cao, X.; Xiong, Y.; Sun, J.; Xie, X.; Sun, Q.; Wang, Z. L. Multidiscipline Applications of Triboelectric Nanogenerators for the Intelligent Era of Internet of Things. Nano-Micro Letters 2022, 15 (1). doi.org/10.1007% 2Fs40820-022-00981-8
[9]. Ahmed, F.; Mohanta, J. C.; Keshari, A.; Yadav, P. S. Recent Advances in Unmanned Aerial Vehicles: A Review. Arabian Journal for Science and Engineering 2022, 47 (7), 7963-7984. dx.doi.org/10.1007/s13369-022-06738-0
[10]. Zhang, Z.; Zhu, L. A Review on Unmanned Aerial Vehicle Remote Sensing: Platforms, Sensors, Data Processing Methods, and Applications. Drones 2023, 7, 398. dx.doi.org/10.3390/drones7060398
[11]. Gopikumar, S. Evaluation of Landfill Leachate Biodegradability Using IoT through Geotracking Sensor Based Drone Surveying. Environmental Research 2023, 236, 116883. doi.org/10.1016/j.envres.2023.116883
[12]. Casana, J.; Fowles, S.; Montgomery, L. M.; Mermejo, R.; Ferwerda, C.; Hill, A.; Adler, M. Multi-Sensor Drone Survey of Ancestral Agricultural Landscapes at Picuris Pueblo, New Mexico. Journal of Archaeological Science 2023, 157, 105837. doi.org/10.1016/j.jas.2023.105837
[13]. Afshar-Mohajer, N.; Wu, C. Use of a Drone-Based Sensor as a Field-Ready Technique for Short-Term Concentration Mapping of Air Pollutants: A Modeling Study. Atmospheric Environment 2023, 294, 119476. doi.org/10.1016/j.atmosenv.2022.119476
[14]. Severin, T.; Söffker, D. Sensor Optimization for Altitude Estimation of Spraying Drones in Vineyards. IFAC-PapersOnLine 2022, 55 (32), 107-112. doi.org/10.1016/j.ifacol.2022.11.123
[15]. Hu, X.; Assaad, R. H. The Use of Unmanned Ground Vehicles (Mobile Robots) and Unmanned Aerial Vehicles (Drones) in the Civil Infrastructure Asset Management Sector: Applications, Robotic Platforms, Sensors, and Algorithms. Expert Systems With Applications 2023, 232, 120897. doi.org/10.1016/j.eswa.2023.120897
[16]. Dering, G. M.; Micklethwaite, S.; Thiele, S. T.; Vollgger, S. A.; Cruden, A. R. Review of Drones, Photogrammetry and Emerging Sensor Technology for the Study of Dykes: Best Practises and Future Potential. Journal of Volcanology and Geothermal Research 2019, 373, 148-166. doi.org/10.1016/j.jvolgeores.2019.01.018
[17]. Ma, J.; Zhu, J.; Ma, P.; Yang, J.; Wang, Z. L.; Cao, X. Fish Bladder Film-Based Triboelectric Nanogenerator for Noncontact Position Monitoring. ACS Energy Letters 2020, 5 (9), 3005-3011. dx.doi.org/10.1021/acsenergylett.0c01062
[18]. Zhou, H.; Liu, F.; Chen, J.; Wang, J.; Wu, Y.; Jin, C.; Chang, S.; Xia, L. D.; Zhang, C.; Jiang, J.; Dong, K.; Zhang, C.; Sun, L.; Xuan, W.; Zhao, P.; Jin, H.; Dong, S.; Luo, J. Computer Aided Design Automation for Triboelectric Nanogenerators. Nano Energy 2023, 118, 108963. doi.org/10.1016/j.nanoen.2023.108963
[19]. Pradel, K. C.; Fukata, N. Systematic Optimization of Triboelectric Nanogenerator Performance through Surface Micropatterning. Nano Energy 2021, 83, 105856. doi.org/10.1016/j.nanoen.2021.105856
[20]. Sun, Y.; Yu, Y.; Gao, Q.; Zhang, X.; Zhang, J.; Wang, Y.; He, S.; Li, H.; Wang, Z. L.; Cheng, T. Enhancing Performance of Triboelectric Nanogenerator by Accelerating the Charge Transfer Strategy. Nano Energy 2024, 121, 109194. doi.org/10.1016/j.nanoen.2023.109194
[21]. Wang, Y.; Liu, X.; Zheng, Z.; Yin, Y.; Wang, X.; You, Z. Numerical Analysis and Structural Optimization of Cylindrical Grating-Structured Triboelectric Nanogenerator. Nano Energy 2021, 90, 106570. doi.org/10.1016/j.nanoen.2021.106570
[22]. Menge, H. G.; Huynh, N. D.; Hwang, H. J.; Han, S. H.; Choi, D.; Park, Y. Designable Skin-like Triboelectric Nanogenerators Using Layer-by-Layer Self-Assembled Polymeric Nanocomposites. ACS Energy Letters 2021, 6 (7), 2451-2459. dx.doi.org/10.1021/acsenergylett.1c00739
[23]. Fu, S.; Wu, H.; Shan, C.; Li, K.; He, W.; Li, Q.; Yu, X.; Du, S.; Gui, L.; Hu, C. Ultra-Durable and High-Output Triboelectric Nanogenerator Based on Coupling of Soft-Soft Contact and Volume Effect. Nano Energy 2023, 116, 108850. doi.org/10.1016/j.nanoen.2023.108850
[24]. Rastegardoost, M. M.; Tafreshi, O. A.; Saadatnia, Z.; Ghaffari-Mosanenzadeh, S.; Serles, P.; Filleter, T.; Park, C.; Naguib, H. E. Highly Durable Triboelectric Nanogenerators Based on Fibrous Fluoropolymer Composite Mats with Enhanced Mechanical and Dielectric Properties. Materials Today Energy 2023, 38, 101431. doi.org/10.1016/j.mtener.2023.101431
[25]. He, L.; Zhang, C.; Zhang, B.; Gao, Y.; Yuan, W.; Li, X.; Zhou, L.; Zhao, Z.; Wang, Z. L.; Wang, J. A High-Output Silk-Based Triboelectric Nanogenerator with Durability and Humidity Resistance. Nano Energy 2023, 108, 108244. doi.org/10.1016/j.nanoen.2023.108244
[26]. Xu, S.; Nie, W.; Sun, J.; Sun, P.; Jia, H.; Zheng, X.; Sun, Y.; Xu, Z.; Liu, L. Multi-Mode and Durable Fiber Triboelectric Nanogenerator for Power and Sensor Enabled by Hookean Vascular Stent Structure. Chemical Engineering Journal 2023, 472, 145088. doi.org/10.1016/j.cej.2023.145088
[27]. Gao, M.; Kim, S.; Li, Y.; Ramaswamy, S. H.; Choi, J. Triboelectric Nanogenerator with Enhanced Output and Durability Based on Si-DLC Films. Nano Energy 2023, 105, 107997. dx.doi.org/10.1016/j.nanoen.2022.107997
[28]. Wang, Y.; Yang, Y.; Wang, Z. L. Triboelectric Nanogenerators as Flexible Power Sources. Npj Flexible Electronics 2017, 1 (1). dx.doi.org/10.1038/s41528-017-0007-8
[29]. Trinh, V.-L.; Chung, C.-K. Advances in Triboelectric Nanogenerators for Sustainable and Renewable Energy: Working Mechanism, Tribo-Surface Structure, Energy Storage-Collection System, and Applications. Processes 2023, 11, 2796. doi.org/10.3390/pr11092796
[30]. Qin, T.; Zhang, G.; Yang, L.; He, Y. Research on the Endurance Optimisation of Multirotor UAVs for High-Altitude Environments. Drones 2023, 7, 469. dx.doi.org/10.3390/drones7070469
[31]. Gao, M.; Hugenholtz, C. H.; Fox, T. A.; Kucharczyk, M.; Barchyn, T. E.; Nesbit, P. R. Weather Constraints on Global Drone Flyability. Scientific Reports 2021, 11 (1). nature.com/articles/s41598-021-91325-w
[32]. Cui, J., Liu, T., Zheng, Y., Bai, S., Li, X., Xue, C. Optimization of Electromagnetic-Triboelectric Wind Energy Harvester Based on Coaxial Reversed Mechanism with Tip Discharge. Energy Conversion and Management 2023, 293, 117456. doi.org/10.1016/j.enconman.2023.117456
[33]. Bai, Q., Gan, C. Z., Zhou, T., Du, Z. W., Wang, J. H., Wang, Q., Wei, K. X., Zo, H. X. A Triboelectric-Piezoelectric-Electromagnetic hybrid wind energy harvestermbased on a snap-through bistable mechanism. Energy Conversion and Management 2024, 306, 118323. doi.org/10.1016/j.enconman.2024.118323
[34]. Xin, Y.; Du, T.; Liu, T.; Sun, P.; Zhu, M.; Zheng, L.; Du, H.; Zou, Y.; Xu, M. Triboelectric nanogenerator embedded cylindrical roller bearing for rotational energy harvesting and self-powered fault diagnosis. Sensors and Actuators A: Physical 2023, 362, 114664.
[35] Mudgal, T.; Tiwari, M.; Bharti, D. Cylindrical-electrode Triboelectric Nanogenerator for Low-speed Wind Energy Harvesting. Nano Energy 2024, Preprint. doi.org/10.1016/j.nanoen.2024.109388
[36] Choi, J.; Jeong, J. G.; Kang, M.; Ko, H.-J.; Kim, T. H.; Park, K.; Kim, J.; Pyo, S. Externally motionless triboelectric nanogenerator based on vortex-induced rolling for omnidirectional wind energy harvesting. Nano Energy 2024, 119, 109071.
[37] Su, E.; Li, H.; Zhang, J.; Xu, Z.; Chen, B.; Cao, L. N. Y.; Wang, Z. L. Rationally designed Anti-Glare panel arrays as highway wind energy harvester. Advanced Functional Materials 2023, 33 (17).
[38] Shi, Y.; Liu, J.; Liu, J.; Zhao, C.; Shan, B.; Chen, N.; Zhou, Z.; Wang, C.; Pan, X.; Mi, J.; Xu, M. A wind-driven rotational direct current triboelectric nanogenerator for self-powered inactivation of seawater microorganisms. Materials Today Energy 2022, 26, 100991.
[39] Li, X.; Cao, Y.; Yu, X.; Yang, X.; Yang, Y.; Liu, S.; Cheng, T.; Wang, Z. L. Breeze-driven triboelectric nanogenerator for wind energy harvesting and application in smart agriculture. Applied Energy 2022, 306, 117977.
[40] Zhang, C.; Liu, Y.; Zhang, B.; Ou, Y.; Yuan, W.; He, L.; Wei, X.; Wang, J.; Wang, Z. L. Harvesting wind energy by a triboelectric nanogenerator for an intelligent High-Speed Train system. ACS Energy Letters 2021, 1490-1499.

1. A hybrid unmanned aerial vehicle, comprising:
an aerial unit including a plurality of rotors; and
a triboelectric nanogenerator (TENG) system attached to the aerial unit, the TENG system being configured to convert kinetic energy generated by rotations of the plurality of rotors into electrical energy for use as supplemental or alternative power source.

2. The hybrid unmanned aerial vehicle of claim 1, wherein the aerial unit comprises a quadcopter including four rotors.

3. The hybrid unmanned aerial vehicle of claim 1, wherein the TENG system comprises a corresponding number of TENG units for the plurality of rotors, and wherein the TENG units are respectively provided to the plurality of rotors of the aerial unit.

4. The hybrid unmanned aerial vehicle of claim 3, wherein the TENG units are respectively directly connected to the plurality of rotors of the aerial unit below respective propellers.

5. The hybrid unmanned aerial vehicle of claim 3, wherein each of the TENG units comprises a rotor component and a stator component in a co-planar arrangement.

6. The hybrid unmanned aerial vehicle of claim 5, wherein
the rotor component comprises a rotor substrate attached to a respective rotor of the aerial unit, and a dielectric triboelectric layer attached to at least a part of the rotor substrate, and
the stator component comprises a stator substrate and a conductive layer attached to at least a part of the stator substrate on a side facing the rotor component.

7. The hybrid unmanned aerial vehicle of claim 6, wherein the dielectric triboelectric layer comprises a fluorinated ethylene propylene (FEP) film.

8. The hybrid unmanned aerial vehicle of claim 6, wherein the conductive layer comprises silver (Ag) and is configured as a fabric tape.

9. The hybrid unmanned aerial vehicle of claim 6, wherein the stator substrate comprises a curved end on the side facing the rotor component, and the conductive layer is provided on the curved end.

10. The hybrid unmanned aerial vehicle of claim 6, wherein the rotor component is ring-shaped to surround the rotor of the aerial unit, and the stator component is installed on a body of the aerial unit.

11. The hybrid unmanned aerial vehicle of claim 10, wherein at least a part of the stator component is incorporated or embedded in the body of the aerial unit.

12. The hybrid unmanned aerial vehicle of claim 2, wherein a first diagonal pair of rotors and a second diagonal pair of rotors rotate in different directions, and the rotors in each diagonal pair rotate in the same direction.

13. The hybrid unmanned aerial vehicle of claim 12, wherein the TENG units connected to the rotors with matching rotational direction are connected in series, and a first pair of the TENG units and a second pair of the TENG units with opposite rotational directions are connected in parallel.

14. The hybrid unmanned aerial vehicle of claim 6, wherein each TENG unit is configured such that the dielectric triboelectric layer comes into near-contact with the conductive layer with every rotation of the respective rotor of the aerial unit.

15. The hybrid unmanned aerial vehicle of claim 14, wherein each TENG unit is configured to collect electrical energy by rotations of the respective rotor of the aerial unit.

16. The hybrid unmanned aerial vehicle of claim 1, wherein each TENG unit functions as a rotation sensor or an RPM sensor.

17. The hybrid unmanned aerial vehicle of claim 1, further comprising a power storage unit to store the converted electrical energy.

18. The hybrid unmanned aerial vehicle of claim 1, further comprising one or more electronic components,
wherein the converted electrical energy is utilized to power the one or more electronic components.

19. A method of fabricating a triboelectric nanogenerator (TENG) unit for a hybrid unmanned aerial vehicle, the TENG unit comprising a stator component including a stator substrate and a conductive layer, and a rotor component including a rotor substrate and a dielectric triboelectric layer, the method comprising:
providing the stator substrate and the rotor substrate by using 3D printing method;
attaching the dielectric triboelectric layer to at least a part of the rotor substrate; and
attaching the conductive layer to at least a part of the stator component.

20. The method of claim 19, further comprising:
providing the rotor component to a rotor of the hybrid unmanned aerial vehicle such that the rotor component is directly connected to the rotor of the hybrid unmanned aerial vehicle below a corresponding propeller; and
providing the stator component to the hybrid unmanned aerial vehicle such that the rotor component and the stator component are provided in a co-planar arrangement.
